(19) United States
(12) Patent Application Publication
(10) Pub. No.: US 2025/0002674 A1
(43) Pub. Date: Jan. 2, 2025

(54) ELECTROCHEMICAL RECYCLING PROCESS FOR POLYESTERS AND POLYURETHANES

(71) Applicant: UCHIGACO ARGONNE, LLC, Chicago, IL (US)

(72) Inventor: Donghyeon Kang, Naperville, IL (US)

(73) Assignee: UCHIGACO ARGONNE, LLC, Chicago, IL (US)

(21) Appl. No.: 18/217,050

(22) Filed: Jun. 30, 2023

(51) Int. Cl. C08J 11/24

(52) U.S. Cl. CPC C08J 11/24; C08J 2367/02; C08J 2375/04

(57) ABSTRACT

A method of depolymerizing includes passing a current through a cathode to form alkoxy anions from an alcohol, the alkoxy anions reacting with a polyester and/or polyurethane to form monomers from the polyester and/or the polyurethane.

### GOVERNMENT RIGHTS

This invention was made with government support under Contract No. DE-AC02-06CH11357 awarded by the United States Department of Energy to UChicago Argonne, LLC, operator of Argonne National Laboratory. The government has certain rights in the invention.

### FIELD

The present technology is generally related to depolymerization of polymers. Specifically, the present technology is related to electrochemical depolymerization of polyesters and polyurethanes.

### BACKGROUND

Polyesters including polyurethane and polyethylene terephthalate (PET) are some of the most versatile materials in the world. PET is the most abundantly produced plastic, with worldwide polymer production of 30.5 MMTs and a global market of USD 34 billion in 2019, and a compound annual growth rate (CAGR) of 7.8% expected by 2027. Polyurethane ranked second in worldwide polymer production at 27 million metric tons (MMTs) with a global market of USD 72.8 billion in 2021 and it is expected to expand at a compound annual growth rate of 4.3% from 2022 to 2030.

However, polyesters and polyurethanes are made from fossil fuels, and therefore their production emits significant greenhouse gases (GHG). It is estimated that the annual U.S. GHG emissions from polyurethane production are 7.8 million metric tons (MMT CO₂e/year). Furthermore, most polyurethane and PET is not recycled because it is expensive to separate and recycle. Over 75% of used polyurethane products (>20 MMTs) and 95% of used PET products (>36 MMTs) are incinerated or landfilled, releasing toxins and additional CO₂. Additionally, methylene diphenyldiisocyanate (MDI) and toluene diisocyanate (TDI), two of the main precursors for the conventional production of polyurethane, are classified as carcinogenic, mutagenic, and reprotoxic (CMR), which may cause health issues after prolonged exposure. There have been efforts to replace these toxic isocyanate monomers, but production of alternative monomers has failed to reduce GHG emissions.

### SUMMARY

To address the many issues with current polyester and polyurethane production and recycling methods, disclosed herein is an electrochemical system and method for electrochemical depolymerization of polyester and polyurethane. The systems and methods provide selective production of polyester and polyurethane monomers from mixed plastic waste under mild conditions (i.e., temperatures of about 15° C. to about 45° C. and pressure of about 0.5 atm to 1.3 atm). The systems and methods use process electrification, which results in a significant reduction in the overall cost and CO₂ emissions for production of polyester and polyurethane monomers. The systems and methods may use renewable electricity to further reduce GHG emissions, offering a way to make use of excess renewable energy produced during off-peak hours. Additionally, the systems and methods may co-produce H₂ gas and/or HCl, which are commercially valuable chemicals. Thus, the systems and methods provide economically feasible polyester and polyurethane recycling.

In one aspect, a method of depolymerization is disclosed. The method includes passing a current through a cathode to form alkoxy anions from an alcohol, the alkoxy anions reacting with a polyester and/or a polyurethane to form monomers from the polyester and/or the polyurethane.

The alcohol may include methanol, ethanol, propanol, butanol, pentanol, hexanol, or a mixture thereof. The alkoxy anions may include methoxy anions, ethoxy anions, propoxy anions, butoxy anions, pentoxy anions, hexoxy anions, or a mixture thereof. The method may be performed without applying external heat and/or in the absence of caustic base. The polyester may include poly(ethylene terephthalate) (PET), polytrimethylene terephthalate (PTT), poly(butylene terephthalate) (PBT), poly(hexamethylene terephthalate)(PHT), or a combination of two or more thereof. The polyester and/or the polyurethane may be waste materials. The method may further include isolating the monomers from the alcohol. Isolating the monomers from the alcohol may include passing the monomers through a filter in the presence of an organic solvent in which the monomers are soluble.

In another aspect, an electrochemical device is disclosed. The electrochemical device includes a cathode, an anode in electrical communication with the cathode, a catholyte in physical contact with the cathode, an anolyte in physical contact with the anode, a separator separating the catholyte and the anolyte, and a polyester and/or polyurethane disposed in the catholyte. The separator is configured to conduct the cations between the catholyte and the anolyte. The catholyte includes an alcohol and an electrolyte salt including cations.

The catholyte may further comprise alkoxy anions. The alkoxy anions may include methoxy anions, ethoxy anions, propoxy anions, butoxy anions, pentoxy anions, hexoxy anions, or a mixture thereof. The alcohol may include methanol, ethanol, propanol, butanol, pentanol, hexanol, or a mixture thereof. The catholyte may include methoxy anions. The anolyte may include water, alcohol, or a mixture thereof. The electrochemical device may further include a power source in electrical communication with the cathode. The electrochemical device may not include an external heat source and/or a caustic base. The separator may be a NASICON membrane and/or a polymer-based cation exchange membrane.

In another aspect, a process for depolymerizing polyurethane using an electrochemical device is disclosed. The electrochemical device includes a cathode; a catholyte in physical contact with the cathode, the catholyte comprising an alcohol; the polyurethane disposed in the catholyte. The process includes passing a current through the cathode to form alkoxy anions from the alcohol, the alkoxy anions reacting with the polyurethane to form dimethyl carbamate (DMC).

### BRIEF DESCRIPTION OF THE DRAWINGS

FIGS. 1A and 1B show conventional chemical reactions for chemical recycling of polyurethane (FIG. 1A) and polyester terephthalate (PET) (FIG. 1B).

FIG. 2 is an illustration of a process to electrochemically recycle PET polymers.

FIG. 3A is an illustration of an electrochemical cell for electrochemical depolymerization of a polymer.

FIG. 3B is an illustration of an electrochemical cell for electrochemical depolymerization of PET to produce dimethyl terephthalate (DMT).

FIG. 3C is an illustration of an electrochemical cell for electrochemical depolymerization of PET to produce terephthalic acid (TPA).

FIG. 4 is an illustration of another electrochemical cell for electrochemical recycling polymers.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In general, “substituted” refers to an organic group as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group is substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, aryloxy, aralkyloxy, heterocyclyl, heterocyclylalkyl, heterocyclyloxy, and heterocyclylalkoxy groups; carbonyls (oxo); carboxylates; esters; urethanes; oximes; hydroxylamines; alkoxyamines; aralkoxyamines; thiols; sulfides; sulfoxides; sulfones; sulfonyls; pentafluorosulfanyl (i.e., SFs), sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; and nitriles (i.e., CN).

Substituted ring groups such as substituted cycloalkyl, aryl, heterocyclyl and heteroaryl groups also include rings and ring systems in which a bond to a hydrogen atom is replaced with a bond to a carbon atom. Therefore, substituted cycloalkyl, aryl, heterocyclyl and heteroaryl groups may also be substituted with substituted or unsubstituted alkyl, alkenyl, and alkynyl groups as defined below.

The term “alkyl”, by itself or as part of another substituent, means, unless otherwise stated, a saturated monovalent hydrocarbon radical, having, in some embodiments, one to eight (e.g., C₁-C₈ alkyl), or one to six (e.g., C₁-C₆ alkyl), or one to three carbon atoms (e.g., C₁-C₃ alkyl), respectively. The term “alkyl” encompasses straight and branched-chain hydrocarbon groups. Examples of alkyl groups include, but are not limited to, methyl, ethyl, n-propyl, isopropyl, n-butyl, t-butyl, isobutyl, sec-butyl, isopentyl, tert-pentyl, n-pentyl, isohexyl, n-hexyl, n-heptyl, 4-isopropylheptane, n-octyl, and the like. In some embodiments, the alkyl groups are C₁-C₃ alkyl groups (e.g., methyl, ethyl, or isopropyl).

Alkenyl groups include straight and branched chain alkyl groups as defined above, except that at least one double bond exists between two carbon atoms. Alkenyl groups may be substituted or unsubstituted. Alkenyl groups have from 2 to 12 carbon atoms, and typically from 2 to 10 carbons or, in some embodiments, from 2 to 8, 2 to 6, or 2 to 4 carbon atoms. In some embodiments, the alkenyl group has one, two, or three carbon-carbon double bonds. Examples include, but are not limited to vinyl, allyl, —CH═CH(CH₃), —CH═C(CH₃)₂, —C(CH₃)═CH₂, —C(CH₃)═CH(CH₃), —C(CH₂CH₃)═C H₂, among others. Representative substituted alkenyl groups may be mono-substituted or substituted more than once, such as, but not limited to, mono-, di-or tri-substituted with substituents such as those listed above.

The term “alkylene” refers to a straight or branched, saturated, hydrocarbon radical having, in some embodiments, one to six (e.g., C₁-C₆ alkylene), or one to four (e.g., C₁-C₄ alkylene), or one to three (e.g., C₁-C₃ alkylene), or one to two (e.g., C₁-C₂ alkylene) carbon atoms, and linking at least two other groups, i.e., a divalent hydrocarbon radical. When two moieties are linked to the alkylene they can be linked to the same carbon atom (i.e., geminal), or different carbon atoms of the alkylene group. For instance, a straight chain alkylene can be the bivalent radical of —(CH₂)ₙ—, where n is 1, 2, 3, 4, 5 or 6 (i.e., a C₁-C₆ alkylene). Representative alkylene groups include, but are not limited to, methylene, ethylene, propylene, isopropylene, butylene, isobutylene, secbutylene, pentylene, hexylene and the like. In some embodiments, the alkylene groups are C₁-C₃ alkylene groups (e.g., methylene, ethylene, or propylene).

As used herein, the term “alkoxy” refers to an alkyl group, as defined herein, that is attached to the remainder of the molecule via an oxygen atom (e.g., —O—C₁-C₁₂ alkyl, —O—C₁-C₈ alkyl, —O—C₁-C₆ alkyl, or —O—C₁-C₃ alkyl). Non-limiting examples of alkoxy groups include methoxy, ethoxy, n-propoxy, iso-propoxy, n-butoxy, sec-butoxy, n-pentoxy, n-hexoxy, and the like. In some embodiments, the alkoxy groups are C₁-C₆ alkoxy groups (e.g., methoxy, ethoxy, n-propoxy, iso-propoxy, butoxy, pentoxy, or hexyloxy).

Alkynyl groups include straight and branched chain alkyl groups as defined above, except that at least one triple bond exists between two carbon atoms. Alkynyl groups may be substituted or unsubstituted. Alkynyl groups have from 2 to 12 carbon atoms, and typically from 2 to 10 carbons or, in some embodiments, from 2 to 8, 2 to 6, or 2 to 4 carbon atoms. In some embodiments, the alkynyl group has one, two, or three carbon-carbon triple bonds. Examples include, but are not limited to —C≡CH, —C≡CCH₃, —CH₂C≡CCH₃, and —C≡CCH₂CH(CH₂CH₃)₂, among others.

Aryl groups are cyclic aromatic hydrocarbons that do not contain heteroatoms. Aryl groups herein include monocyclic, bicyclic and tricyclic ring systems. Aryl groups may be substituted or unsubstituted. Thus, aryl groups include, but are not limited to, phenyl, azulenyl, heptalenyl, biphenyl, fluorenyl, phenanthrenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. In some embodiments, the aryl groups are phenyl or naphthyl. The phrase “aryl groups” includes groups containing fused rings, such as fused aromatic-aliphatic ring systems (e.g., indanyl, tetrahydronaphthyl, and the like). Representative substituted aryl groups may be mono-substituted (e.g., tolyl) or substituted more than once. For example, monosubstituted aryl groups include, but are not limited to, 2-, 3-, 4-, 5-, or 6-substituted phenyl or naphthyl groups, which may be substituted with substituents such as those listed above.

The term “cycloalkyl” refers to a monocyclic, bicyclic or polycyclic hydrocarbon ring system having, in some embodiments, 3 to 14 carbon atoms (e.g., C₃-C₁₄ cycloalkyl), or 3 to 10 carbon atoms (e.g., C₃-C₁₀ cycloalkyl), or 3 to 8 carbon atoms (e.g., C₃-C₈ cycloalkyl), or 3 to 6 carbon atoms (e.g., C₃-C₆ cycloalkyl) or 5 to 6 carbon atoms (e.g., C₅-C₆ cycloalkyl). Cycloalkyl groups can be saturated or characterized by one or more points of unsaturation (i.e., carbon-carbon double and/or triple bonds), provided that the points of unsaturation do not result in an aromatic system. Examples of monocyclic cycloalkyl groups include, but are not limited to, cyclopropyl, cyclobutyl, cyclopentyl, cyclohexyl, cyclohexeneyl, cyclohexynyl, cycloheptyl, cyclohepteneyl, cycloheptadieneyl, cyclooctyl, cycloocteneyl, cyclooctadieneyl, and the like. The rings of bicyclic and polycyclic cycloalkyl groups can be fused, bridged, or spirocyclic. Non-limiting examples of bicyclic, spirocyclic and polycyclic hydrocarbon groups include bicyclo[2.2.1]heptane, bicyclo[2.2.2]octane, adamantyl, indanyl, spiro[5.5]undecane, spiro[2.2]pentane, spiro[2.2]pentadiene, spiro[2.5]octane, spiro[2.2]pentadiene, and the like. In some embodiments, the cycloalkyl groups of the present disclosure are monocyclic C₃-C₇ cycloalkyl moieties (e.g., cyclopropyl, cyclobutyl, cyclopentyl, cyclohexyl, or cycloheptyl).

Cycloalkylalkyl groups are alkyl groups as defined above in which a hydrogen or carbon bond of an alkyl group is replaced with a bond to a cycloalkyl group as defined above. Cycloalkylalkyl groups may be substituted or unsubstituted. In some embodiments, cycloalkylalkyl groups have from 4 to 16 carbon atoms, 4 to 12 carbon atoms, and typically 4 to 10 carbon atoms. Substituted cycloalkylalkyl groups may be substituted at the alkyl, the cycloalkyl or both the alkyl and cycloalkyl portions of the group. Representative substituted cycloalkylalkyl groups may be mono-substituted or substituted more than once, such as, but not limited to, mono-, di- or tri-substituted with substituents such as those listed above.

Cycloalkenyl groups include cycloalkyl groups as defined above, having at least one double bond between two carbon atoms. Cycloalkenyl groups may be substituted or unsubstituted. In some embodiments the cycloalkenyl group may have one, two or three double bonds but does not include aromatic compounds. Cycloalkenyl groups have from 4 to 14 carbon atoms, or, in some embodiments, 5 to 14 carbon atoms, 5 to 10 carbon atoms, or even 5, 6, 7, or 8 carbon atoms. Examples of cycloalkenyl groups include cyclohexenyl, cyclopentenyl, cyclohexadienyl, cyclobutadienyl, and cyclopentadienyl.

Cycloalkenylalkyl groups are alkyl groups as defined above in which a hydrogen or carbon bond of the alkyl group is replaced with a bond to a cycloalkenyl group as defined above. Cycloalkenylalkyl groups may be substituted or unsubstituted. Substituted cycloalkenylalkyl groups may be substituted at the alkyl, the cycloalkenyl or both the alkyl and cycloalkenyl portions of the group. Representative substituted cycloalkenylalkyl groups may be substituted one or more times with substituents such as those listed above.

Heterocyclyl groups include aromatic (also referred to as heteroaryl) and non-aromatic ring compounds containing 3 or more ring members, of which one or more is a heteroatom such as, but not limited to, N, O, and S. Heterocyclyl groups may be substituted or unsubstituted. In some embodiments, the heterocyclyl group contains 1, 2, 3 or 4 heteroatoms. In some embodiments, heterocyclyl groups include mono-, bi- and tricyclic rings having 3 to 16 ring members, whereas other such groups have 3 to 6, 3 to 10, 3 to 12, or 3 to 14 ring members. Heterocyclyl groups encompass aromatic, partially unsaturated and saturated ring systems, such as, for example, imidazolyl, imidazolinyl and imidazolidinyl groups. The phrase “heterocyclyl group” includes fused ring species including those comprising fused aromatic and non-aromatic groups, such as, for example, benzotriazolyl, 2,3-dihydrobenzo[1,4]dioxinyl, and benzo[1,3]dioxolyl. The phrase also includes bridged polycyclic ring systems containing a heteroatom such as, but not limited to, quinuclidyl. The phrase includes heterocyclyl groups that have other groups, such as alkyl, oxo or halo groups, bonded to one of the ring members, referred to as “substituted heterocyclyl groups”. Heterocyclyl groups include, but are not limited to, aziridinyl, azetidinyl, pyrrolidinyl, imidazolidinyl, pyrazolidinyl, thiazolidinyl, tetrahydrothiophenyl, tetrahydrofuranyl, dioxolyl, furanyl, thiophenyl, pyrrolyl, pyrrolinyl, imidazolyl, imidazolinyl, pyrazolyl, pyrazolinyl, triazolyl, tetrazolyl, oxazolyl, isoxazolyl, thiazolyl, thiazolinyl, isothiazolyl, thiadiazolyl, oxadiazolyl, piperidyl, piperazinyl, morpholinyl, thiomorpholinyl, tetrahydropyranyl, tetrahydrothiopyranyl, oxathiane, dioxyl, dithianyl, pyranyl, pyridyl, pyrimidinyl, pyridazinyl, pyrazinyl, triazinyl, dihydropyridyl, dihydrodithiinyl, dihydrodithionyl, homopiperazinyl, quinuclidyl, indolyl, indolinyl, isoindolyl, azaindolyl (pyrrolopyridyl), indazolyl, indolizinyl, benzotriazolyl, benzimidazolyl, benzofuranyl, benzothiophenyl, benzthiazolyl, benzoxadiazolyl, benzoxazinyl, benzodithiinyl, benzoxathiinyl, benzothiazinyl, benzoxazolyl, benzothiazolyl, benzothiadiazolyl, benzo[1,3]dioxolyl, pyrazolopyridyl, imidazopyridyl (azabenzimidazolyl), triazolopyridyl, isoxazolopyridyl, purinyl, xanthinyl, adeninyl, guaninyl, quinolinyl, isoquinolinyl, quinolizinyl, quinoxalinyl, quinazolinyl, cinnolinyl, phthalazinyl, naphthyridinyl, pteridinyl, thianaphthyl, dihydrobenzothiazinyl, dihydrobenzofuranyl, dihydroindolyl, dihydrobenzodioxinyl, tetrahydroindolyl, tetrahydroindazolyl, tetrahydrobenzimidazolyl, tetrahydrobenzotriazolyl, tetrahydropyrrolopyridyl, tetrahydropyrazolopyridyl, tetrahydroimidazopyridyl, tetrahydrotriazolopyridyl, and tetrahydroquinolinyl groups.

Heteroaryl groups are aromatic ring compounds containing 5 or more ring members, of which, one or more is a heteroatom such as, but not limited to, N, O, and S. Heteroaryl groups may be substituted or unsubstituted. Heteroaryl groups include, but are not limited to, groups such as pyrrolyl, pyrazolyl, triazolyl, tetrazolyl, oxazolyl, isoxazolyl, thiazolyl, pyridinyl, pyridazinyl, pyrimidinyl, pyrazinyl, thiophenyl, benzothiophenyl, furanyl, benzofuranyl, indolyl, azaindolyl (pyrrolopyridinyl), indazolyl, benzimidazolyl, imidazopyridinyl (azabenzimidazolyl), pyrazolopyridinyl, triazolopyridinyl, benzotriazolyl, benzoxazolyl, benzothiazolyl, benzothiadiazolyl, imidazopyridinyl, isoxazolopyridinyl, thianaphthyl, purinyl, xanthinyl, adeninyl, guaninyl, quinolinyl, isoquinolinyl, tetrahydroquinolinyl, quinoxalinyl, and quinazolinyl groups. Heteroaryl groups include fused ring compounds in which all rings are aromatic such as indolyl groups and include fused ring compounds in which only one of the rings is aromatic, such as 2,3-dihydro indolyl groups. Representative substituted heteroaryl groups may be substituted one or more times with various substituents such as those listed above.

The terms “alkyloyl” and “alkyloyloxy” as used herein can refer, respectively, to —C(O)-alkyl groups and —O—C(O)-alkyl groups. Similarly, “aryloyl” and “aryloyloxy” refer to —C(O)-aryl groups and —O—C(O)-aryl groups.

The term “carboxylate” as used herein refers to a —COOH group.

The term “ester” as used herein refers to —COOR⁷⁰ and —C(O)O-G groups. R⁷⁰ is a substituted or unsubstituted alkyl, cycloalkyl, alkenyl, alkynyl, aryl, aralkyl, heterocyclylalkyl or heterocyclyl group as defined herein. G is a carboxylate protecting group. Carboxylate protecting groups are well known to one of ordinary skill in the art. An extensive list of protecting groups for the carboxylate group functionality may be found in Protective Groups in Organic Synthesis, Greene, T.W.; Wuts, P. G. M., John Wiley & Sons, New York, NY, (3rd Edition, 1999) which can be added or removed using the procedures set forth therein and which is hereby incorporated by reference in its entirety and for any and all purposes as if fully set forth herein.

The term “amide” (or “amido”) includes C- and N-amide groups, i.e., —C(O)NR⁷¹R⁷², and —NR⁷¹C(O)R⁷² groups, respectively. R⁷¹ and R⁷² are independently hydrogen, or a substituted or unsubstituted alkyl, alkenyl, alkynyl, cycloalkyl, aryl, aralkyl, heterocyclylalkyl or heterocyclyl group as defined herein. Amido groups therefore include but are not limited to carbamoyl groups (—C(O)NH₂) and formamide groups (—NHC(O)H). In some embodiments, the amide is —NR⁷¹C(O)—(C₁₋₅ alkyl) and the group is termed “carbonylamino,” and in others the amide is —NHC(O)-alkyl and the group is termed “alkanoylamino.”

The term “nitrile” or “cyano” as used herein refers to the —CN group.

Urethane groups include N- and O-urethane groups, i.e., —NR⁷³C(O)OR⁷⁴ and —OC(O)NR⁷³R⁷⁴ groups, respectively. R⁷³ and R⁷⁴ are independently a substituted or unsubstituted alkyl, alkenyl, alkynyl, cycloalkyl, aryl, aralkyl, heterocyclylalkyl, or heterocyclyl group as defined herein. R⁷³ may also be H.

The term “amine” (or “amino”) as used herein refers to —NR⁷⁵R⁷⁶ groups, wherein R⁷⁵ and R⁷⁶ are independently hydrogen, or a substituted or unsubstituted alkyl, alkenyl, alkynyl, cycloalkyl, aryl, aralkyl, heterocyclylalkyl or heterocyclyl group as defined herein. In some embodiments, the amine is alkylamino, dialkylamino, arylamino, or alkylarylamino. In other embodiments, the amine is NH₂, methylamino, dimethylamino, ethylamino, diethylamino, propylamino, isopropylamino, phenylamino, or benzylamino.

The term “sulfonamido” includes S- and N-sulfonamide groups, i.e., —SO₂NR⁷⁸R⁷⁹ and —NR⁷⁸SO₂R⁷⁹ groups, respectively. R⁷⁸ and R⁷⁹ are independently hydrogen, or a substituted or unsubstituted alkyl, alkenyl, alkynyl, cycloalkyl, aryl, aralkyl, heterocyclylalkyl, or heterocyclyl group as defined herein. Sulfonamido groups therefore include but are not limited to sulfamoyl groups (—SO₂NH₂). In some embodiments herein, the sulfonamido is —NHSO₂-alkyl and is referred to as the “alkylsulfonylamino” group.

The term “thiol” refers to —SH groups, while “sulfides” include —SR⁸⁰ groups, “sulfoxides” include —S(O)R⁸¹ groups, “sulfones” include —SO₂R⁸² groups, “sulfonyls” include —SO₂OR⁸³, and “sulfonates” include —SO₃⁻. R⁸⁰, R⁸¹, R⁸², and R⁸³ are each independently a substituted or unsubstituted alkyl, cycloalkyl, alkenyl, alkynyl, aryl aralkyl, heterocyclyl or heterocyclylalkyl group as defined herein. In some embodiments the sulfide is an alkylthio group, —S-alkyl.

The term “urea” refers to —NR⁸⁴—C(O)—NR⁸⁵R⁸⁶ groups. R⁸⁴, R⁸⁵, and R⁸⁶ groups are independently hydrogen, or a substituted or unsubstituted alkyl, alkenyl, alkynyl, cycloalkyl, aryl, aralkyl, heterocyclyl, or heterocyclylalkyl group as defined herein.

The term “amidine” refers to —C(NR⁸⁷)NR⁸⁸R⁸⁹ and —NR⁸⁷C(NR⁸⁸)R⁸⁹, wherein R⁸⁷, R⁸⁸, and R⁸⁹ are each independently hydrogen, or a substituted or unsubstituted alkyl, cycloalkyl, alkenyl, alkynyl, aryl aralkyl, heterocyclyl or heterocyclylalkyl group as defined herein.

The term “guanidine” refers to —NR⁹⁰C(NR⁹¹)NR⁹²R⁹³, wherein R⁹⁰, R⁹¹, R⁹² and R⁹³ are each independently hydrogen, or a substituted or unsubstituted alkyl, cycloalkyl, alkenyl, alkynyl, aryl aralkyl, heterocyclyl or heterocyclylalkyl group as defined herein.

The term “enamine” refers to —C(R⁹⁴)═C(R⁹⁵)NR⁹⁶R⁹⁷ and —NR⁹⁴C(R⁹⁵)═C(R⁹⁶)R⁹⁷, wherein R⁹⁴, R⁹⁵, R⁹⁶ and R⁹⁷ are each independently hydrogen, a substituted or unsubstituted alkyl, cycloalkyl, alkenyl, alkynyl, aryl aralkyl, heterocyclyl or heterocyclylalkyl group as defined herein.

The term “halogen” or “halo” as used herein refers to bromine, chlorine, fluorine, or iodine. In some embodiments, the halogen is fluorine. In other embodiments, the halogen is chlorine or bromine.

The term “hydroxyl” as used herein can refer to —OH or its ionized form, —O⁻. A “hydroxyalkyl” group is a hydroxyl-substituted alkyl group, such as HO—CH₂—.

The term “imide” refers to —C(O)NR⁹⁸C(O)R⁹⁹, wherein R⁹⁸ and R⁹⁹ are each independently hydrogen, or a substituted or unsubstituted alkyl, cycloalkyl, alkenyl, alkynyl, aryl aralkyl, heterocyclyl or heterocyclylalkyl group as defined herein.

The term “imine” refers to —CR¹⁰⁰(NR¹⁰¹) and —N(CR¹⁰⁰R¹⁰¹) groups, wherein R¹⁰⁰ and R¹⁰¹ are each independently hydrogen or a substituted or unsubstituted alkyl, cycloalkyl, alkenyl, alkynyl, aryl aralkyl, heterocyclyl or heterocyclylalkyl group as defined herein, with the proviso that R¹⁰⁰ and R¹⁰¹ are not both simultaneously hydrogen.

The term “nitro” as used herein refers to an —NO₂ group.

The term “trifluoromethyl” as used herein refers to —CF₃.

The term “trifluoromethoxy” as used herein refers to —OCF₃.

The term “azido” refers to —N₃.

The term “trialkyl ammonium” refers to a —N(alkyl)₃ group. A trialkylammonium group is positively charged and thus typically has an associated anion, such as halogen anion.

The term “isocyano” refers to —NC.

The term “isothiocyano” refers to —NCS.

The term “pentafluorosulfanyl” refers to —SF₅.

This disclosure also contemplates isomers of the compounds described herein (e.g., stereoisomers, and atropisomers). For example, certain compounds of the present disclosure possess asymmetric carbon atoms (chiral centers), or hindered rotation about a single bond; the racemates, diastereomers, enantiomers, and atropisomers (e.g., Rₐ, Sₐ, P, and M isomers) of which are all intended to be encompassed within the scope of the present disclosure. Stereoisomeric forms may be defined, in terms of absolute stereochemistry, as (R) or (S), and/or depicted uses dashes and/or wedges. When a stereochemical depiction (e.g., using dashes, [symbol] , and/or wedges, [symbol] ) is shown in a chemical structure, or a stereochemical assignment (e.g., using (R) and(S) notation) is made in a chemical name, it is meant to indicate that the depicted isomer is present and substantially free of one or more other isomer(s) (e.g., enantiomers and diastereomers, when present). “Substantially free of” other isomer(s) indicates at least an 70/30 ratio of the indicated isomer to the other isomer(s), more preferably 80/20, 90/10, or 95/5 or more. In some embodiments, the indicated isomer will be present in an amount of at least 99%. A chemical bond to an asymmetric carbon that is depicted as a solid line ( [symbol] ) indicates that all possible stereoisomers (e.g., enantiomers, diastereomers, racemic mixtures, etc.) at that carbon atom are included. In such instances, the compound may be present as a racemic mixture, scalemic mixture, or a mixture of diastereomers.

Disclosed herein are energy-efficient and cost-effective methods and systems for recycling polyesters and polyurethanes. These methods and systems use electrochemical depolymerization of polyesters and polyurethanes under mild conditions (i.e., temperatures of about 15° C. to about 45° C. and pressure of about 0.5 atm to 1.3 atm) to produce monomers of polyesters and polyurethanes. These monomers may be used to manufacture new polyesters and polyurethanes as part of a closed-loop supply chain.

Conventional methods of recycling polyesters and polyurethanes include mechanical recycling and chemical recycling. In the U.S., 3 MMTs of PET is consumed annually but only 18.5% is re-purposed by mechanical recyclers. While mechanical recycling of PET is currently preferred, products of mechanical recycling are mostly low-quality PET chips, which are not useful for food and beverage packaging where the demand for PET is highest.

Chemical recycling of polyesters and polyurethanes is desirable because it may produce raw materials that can be used as feedstock for synthesis of new polyesters and polyurethanes and/or as resources for other processes. Also, chemical recycling may reduce GHG emission originating from the synthesis of polyesters and polyurethanes monomers from petroleum products.

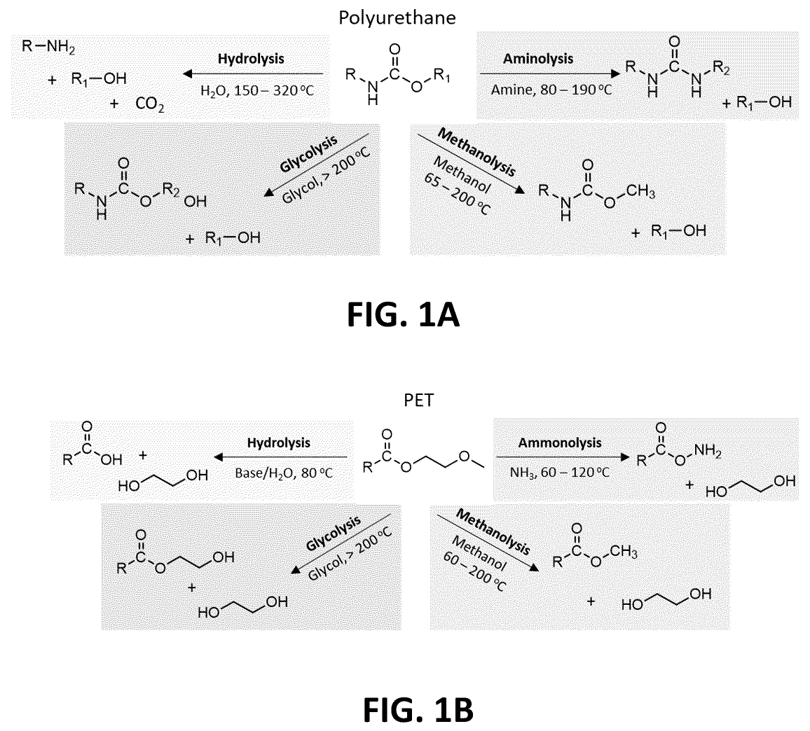

FIGS. 1A and 1B show conventional chemical reactions for chemical recycling of polyurethane (FIG. 1A) and polyethylene terephthalate (PET) (FIG. 1B). These conventional chemical recycling processes include hydrolysis, glycolysis, aminolysis, ammonolysis, and methanolysis. All of these conventional processes are conducted at elevated temperatures of about 60° C. to about 320° C., increasing energy use and processing costs. Many of the processes also use caustic bases, increasing processing costs and making processing more difficult. Furthermore some processes also occur under high pressure, further complicating processing and increasing costs. These processing conditions increase cost, energy consumption, and GHG emissions.

For example, catalytic hydrogenation of polyurethane using iridium-based catalysts produced aniline molecules under 29.6 atm H₂ at a temperature of 150° C. Glycolysis and methanolysis processes for polyurethane foam generally use reaction temperatures greater than 200° C. Base-catalyzed methanolysis of polyurethane foams occurs at lower temperatures than glycolysis and methanolysis, but still at somewhat elevated temperatures (e.g., 65° C.), and use high concentrations of expensive and caustic inorganic or organic bases such as potassium tert-butoxide (tert-BuOK) or 1,5,7-triazabicyclo[4.4.0]dec-5-ene (TBD) catalysts. Therefore, chemical recycling of polyesters and polyurethanes using energy-efficient pathways without toxic chemicals operating under mild conditions has remained unrealized.

The methods and systems for recycling polyesters and polyurethanes disclosed herein are conducted without the use of external heating, applied pressure, or caustic bases. Furthermore, these methods and systems may be conducted without first pre-sorting mixed plastic waste. The methods and systems also avoid the use or production of isocyanate monomers (e.g., toluene diisocyanate (TDI) and methylene diphenyl diisocyanate (MDI)) that are typically used to produce polyurethane. In this way, the methods and systems eliminate the use of strong base and toxic chemicals which have been used for the conventional PU and PET depolymerization processes to recover the monomers.

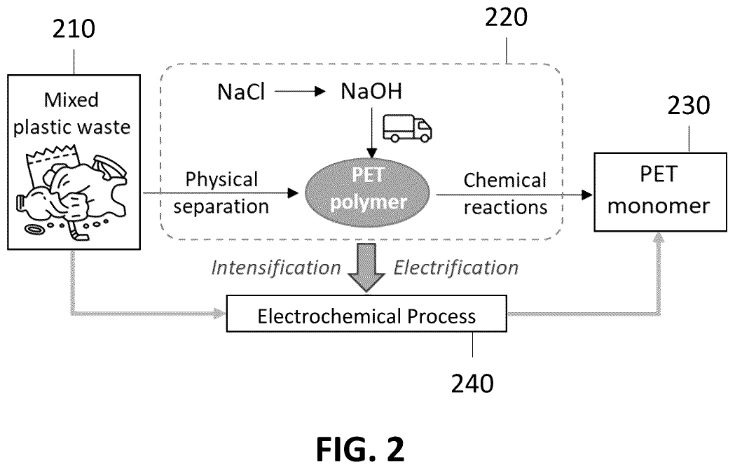

FIG. 2 is a schematic illustration comparing a conventional process 220 to chemically recycle PET polymers as compared to the electrochemical process 240 for recycling PET polymers. The conventional process 220 includes physical separation of PET polymer from mixed plastic waste 210, mixing the separated PET polymer with caustic base (e.g., NaOH), and heating the mixture to an elevated temperature (e.g. 60° C. to 320° C.) to induce the chemical reactions that produce PET monomers 230. In contrast, the electrochemical process 240 does not require separation of the PET polymer from the mixed plastic waste 210, nor does it require caustic bases, elevated temperatures, or elevated pressures. Instead, the mixed plastic waste is subjected to the electrochemical process 240 under mild conditions (i.e., temperatures of about 15° C. to about 45° C. and pressure of about 0.5 atm to 1.3 atm), producing PET monomers 230.

In one aspect, methods of producing polyester monomers and/or polyurethane monomers from polyester and polyurethane, respectively, are disclosed. The methods use an electrochemical reaction to generate reactive alkoxy anion species from an organic alcohol. The generated alkoxy anions are electrochemically active anions. produced by electrochemically reducing the alcohol. The generated alkoxy anions are highly reactive with polyester and polyurethane and propagate in-situ depolymerization of the polyester and polyurethane. The generated alkoxy anions preferentially cleave ester bonds in polyester, providing selective polyester depolymerization reactions.

Polyesters may be any polymers containing repeating ester functional groups in the main chain of the polymer. Polyesters are represented by Formula I:

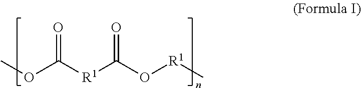

wherein R¹ and R² are each independently substituted or unsubstituted alkyl, alkenyl, alkynyl, cycloalkyl, aryl, aralkyl, heterocyclylalkyl, or heterocyclyl group as defined herein. R¹ and R² may each independently be —C₁-C₇ alkyl, —C₁-C₇ carbonyl, —C₁ -C₇ alkoxy, —(C1-C7 alkylene), C3-C7 cycloalkyl, or C3-C7 aryl, or a combination thereof; and n is 3 to 5000. For example, the polyester may include poly(ethylene terephthalate) (PET), polytrimethylene terephthalate (PTT), poly(butylene terephthalate) (PBT). poly(hexamethylene terephthalate)(PHT), and combinations of two or more thereof.

Polyurethanes may be any polymers that includes repeating urethane (also called carbamate) functional groups in the main chain of the polymer. Polyurethanes are represented by Formula II:

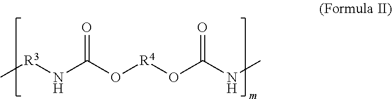

wherein R³ and R⁴ are each independently substituted or unsubstituted alkyl, alkenyl, alkynyl, cycloalkyl, aryl, aralkyl, heterocyclylalkyl, or heterocyclyl group as defined herein. R¹ and R² may each independently be —C₁-C₇ alkyl, —C₁-C₇ carbonyl, —C₁-C₇ alkoxy, —(C1-C7 alkylene), C3-C7 cycloalkyl, or C3-C7 aryl, or a combination thereof; and m is 3 to 5000.

The alcohol is an organic solvent that includes a hydroxyl (—OH) functional group bound to a saturated carbon atom. Examples of alcohols include methanol (CH₃OH), ethanol (C₂H₅OH), propanol (C₃H₇OH), butanol (C₄H₉OH), pentanol (C₅H₁₁OH), and mixtures of two or more thereof.

The electrochemically generated alkoxy anion is a reduced form of the alcohol, and therefore the type of alkoxy anion generated depends on the type of alcohol present in the system. Methanol generates the reactive chemical species methoxide (CH₃O⁻)). Ethanol generates the reactive chemical species ethoxide (C₂H₅O⁻). Propanol generates the reactive chemical species propoxide (C₃H₇O⁻). Butanol generates the reactive chemical species butoxide (C₄H₉O⁻). Pentanol generates the reactive chemical species pentoxide (C₅H₁₁O⁻).

The electrochemically generated reactive chemical species are selectively active for depolymerization of polyester and polyurethane. The reactive chemical species propagate in-situ depolymerization of polyester and polyurethane inside the electrochemical cell that generates the reactive chemical species. For polyesters, the depolymerization reaction cleaves the polymer at the ester functional groups, producing monomers with ester functional groups. For polyurethanes, the depolymerization reaction cleaves the polymer at the urethane functional groups, producing monomers with urethane functional groups.

Because of the selectivity of the electrochemical depolymerization reaction, mixed waste plastics do not need to be sorted prior to electrochemical depolymerization. The reactive chemical species selectively cleave ester bonds of polyester and polyurethane, leaving other plastics that do not contain ester bonds intact during the process. Selectivity arises from the operation at under mild conditions (i.e., temperatures of about 15° C. to about 45° C. and pressure of about 0.5 atm to 1.3 atm), at which the depolymerization of other types of plastics does not occur.

The produced polyester and polyurethane monomers can be easily separated from the other types of plastics because the other types of plastics do not depolymerize under these conditions. The produced monomers may be dissolved in another organic solvent in which they are soluble (e.g., chloroform), and the monomers may be isolated from the alcohol and unreacted polymers. Isolation may be via mechanical or chemical separation. For example, the produced monomers may be separated by filtration, distillation, crystallization, or membrane separation. In some embodiments, the produced monomers are dissolved in chloroform and passed through a filter to isolate the produced monomers from the alcohol phase and unreacted polymers.

As an example, without being bound by any theory, the following reactions may occur in the electrochemical cell during depolymerization of PET in a methanol solvent.

### Cathode Reaction

2MeOH+2e⁻→2MeO⁻+H_{2(g)}

2MeO⁻+PET→DMT+EG*

EG*+2Na⁺→Na-EG*-Na

### Anode Reaction

2H₂O→4H⁺+4e⁻+O_{2(g)}; or

2Cl⁻→2e⁻+Cl_{2(g)}

wherein:

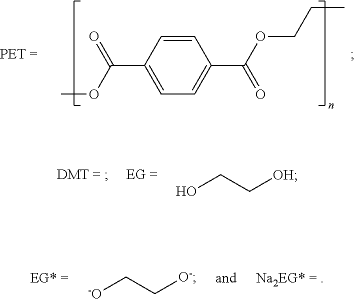

Depolymerization of PET may produce the monomer dimethyl terephthalate (DMT). When the depolymerization reactions occur in the presence of water, depolymerization of PET may produce the monomer terephthalic acid (TPA). Without being bound by any theory, when water is present during depolymerization, water electrolysis may occur at the cathode, producing H₂ and OH⁻, and the OH⁻ may react with DMT to produce TPA. DMT and TPA may be separated from the reaction mixture and used for the production of new polymers. DMT may be subjected to a transesterification reaction to produce different polyesters, including PET, PTT, PBT, and PHT. The produced polyesters may be used as consumer plastics.

Depolymerization of polyurethane produces the monomer dimethyl carbamate (DMC). The production of DMC is an advantage over conventional methods to depolymerize polyurethane, which produce toxic isocyanate monomers including toluene diisocyanate (TDI) and methylene diphenyl diisocyanate (MDI). DMC may be subjected to a transcarbomoylation reaction to produce polyurethanes. The produced polyurethanes may be used as consumer plastics.

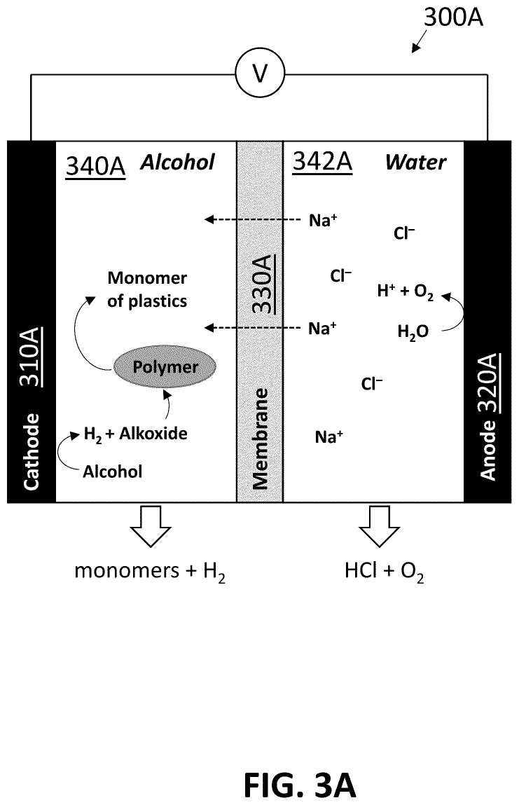

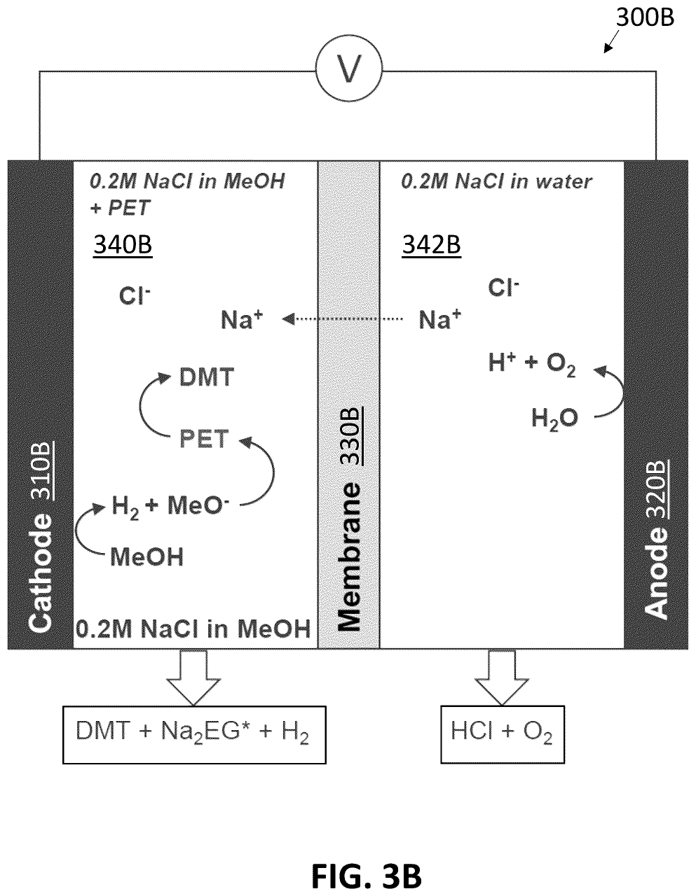

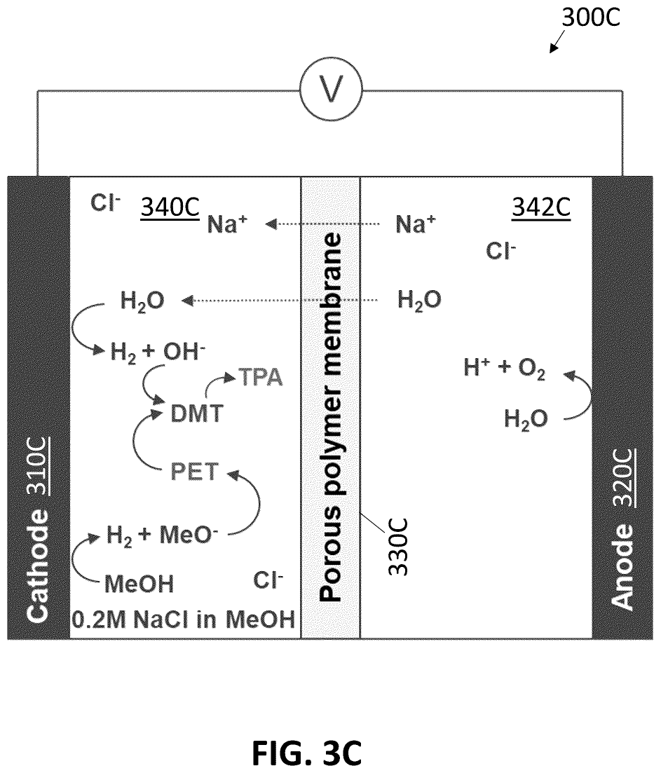

In another aspect, an electrochemical device for producing polyester and/or polyurethane monomers from polyester and polyurethane, respectively, is disclosed. FIG. 3A is a schematic illustration of the electrochemical cell 300A for electrochemically depolymerizing polymers. The electrochemical cell 300A includes a cathode 310A, an anode 320A, and a membrane 330A between the cathode 310A and anode 320A. The electrochemical cell 300A includes two electrolytes. A catholyte 340A on the cathode-side of the cell and an anolyte 342A on the anode-side of the cell, with the membrane 330A separating the two electrolytes.

The catholyte 340A may include a supporting electrolyte salt (also referred to herein as an electrolyte salt; e.g., NaCl) in a concentration of about 0.01 M to about 1 M (e.g., 0.05 M, 0.1 M, 0.2 M, 0.3 M, 0.4 M, 0.5 M, 0.6 M, 0.7 M, 0.8 M, 0.9 M, 1 M, or any value therebetween) dissolved in the organic alcohol solvent (e.g., methanol, ethanol, propanol, butanol, pentanol, hexanol, or a mixture thereof). The anolyte 342A may include the electrolyte salt and water, organic alcohol, or a mixture of water and organic alcohol as solvent. The membrane 330A may conduct the electrolyte salt cations (e.g., Na⁺) while preventing the transport of other species. The two electrolytes are separated to prevent rapid quenching of the electrochemically generated reactive species from the organic solvent. For example, the membrane 330A may be a commercially available Na-ion superconducting membrane (e.g., NASICON) and/or a polymer-based cation exchange membrane.

The cathode 310A and the anode 320A may be conductive metals. The cathode 310A and/or the anode 320A may be any other conductive metal that is substantially inert in the electrolyte. For example, the cathode 310A and/or the anode 320A may be nickel, iridium, stainless steel, titanium, platinum-coated titanium, platinum, palladium, gold, or a combination of two or more thereof.

The reactive species are generated in the catholyte 340A at the cathode 310A. The reactive species react with polyester and/or polyurethane present on the cathode-side of the cell to produce the monomers as described above. The polymers present in the cathode-side of the cell may be single polymers or mixtures of different polymers, and the reactive species may selectively react with polyester and polyurethane. The polymers may be waste plastics.

The electrochemical cell 300A includes a power source to apply a current to the cathode. The applied current may be about 10 mA/cm² to about 200 mA/cm². For example, the applied current may be about 10 mA/cm², 25 mA/cm², 50 mA/cm², 75 mA/cm², 100 mA/cm², 125 mA/cm², 150 mA/cm², 175 mA/cm², 200 mA/cm², or any value therebetween.

The reaction time may be about 15 minutes to about 20 hours. For example, the reaction time may be about 15 minutes, 30 minutes, 1 hour, 2 hours, 4 hours, 6 hours, 8 hours, 10 hours, 20 hours, or any value therebetween.

FIG. 3B is a schematic illustration of the electrochemical cell 300B for electrochemically depolymerizing PET to produce DMT. The electrochemical cell 300B includes a cathode 310B, an anode 320B, and a membrane 330B between the cathode 310B and anode 320B. The cathode 310B and anode 320B may include the same materials as in electrochemical cell 300A in FIG. 3A. The electrochemical cell 300B includes two electrolytes. A catholyte 340B on the cathode-side of the cell and an anolyte 342B on the anode-side of the cell, with the membrane 330B separating the two electrolytes. The membrane 330B may be a Na-ion superconducting membrane (e.g., NASICON, Na₁₊ₓZr₂SiₓP₃₋ₓO₁₂, 0<x<3). The Na-ion superconducting membrane may be commercially available. The Na-ion superconducting membrane may only conduct Na⁺ ions and may not conduct water.

The catholyte 340B may include a supporting electrolyte salt (also referred to herein as an electrolyte salt; e.g., NaCl) in a concentration of about 0.01 M to about 1 M (e.g., 0.05 M, 0.1 M, 0.2 M, 0.3 M, 0.4 M, 0.5 M, 0.6 M, 0.7 M, 0.8 M, 0.9 M, 1 M, or any value therebetween) dissolved in the organic alcohol solvent (e.g., methanol, ethanol, propanol, butanol, pentanol, hexanol, or a mixture thereof). For example, the catholyte 340B may be 0.2 M NaCl in methanol. The anolyte 342B may include the electrolyte salt and water, organic alcohol, or a mixture of water and organic alcohol as solvent. For example, the anolyte 342B may include 0.2 M NaCl in water.

FIG. 3C is a schematic illustration of the electrochemical cell 300C for electrochemically depolymerizing PET to produce TPA. The electrochemical cell 300C includes a cathode 310C, an anode 320C, and a membrane 330C between the cathode 310C and anode 320C. The cathode 310C and anode 320C may include the same materials as in electrochemical cell 300A in FIG. 3A. The electrochemical cell 300C may include two electrolytes. A catholyte 340C on the cathode-side of the cell and an anolyte 342C on the anode-side of the cell, with the membrane 330C separating the two electrolytes. The membrane 330C may be a porous polymer membrane. The porous polymer membrane may be commercially available. The porous polymer membrane may conduct Na⁺ ions and may be water permeable. For example, the porous polymer membrane may be a perfluorosulfonic acid (PFSA) membrane based on a PFSA/polytetrafluoroethylene (PTFE) copolymer (e.g., Nafion chlor-alkali membrane).

The catholyte 340C may include a supporting electrolyte salt (also referred to herein as an electrolyte salt; e.g., NaCl) in a concentration of about 0.01 M to about 1 M (e.g., 0.05 M, 0.1 M, 0.2 M, 0.3 M, 0.4 M, 0.5 M, 0.6 M, 0.7 M, 0.8 M, 0.9 M, 1 M, or any value therebetween) dissolved in the organic alcohol solvent (e.g., methanol, ethanol, propanol, butanol, pentanol, hexanol, or a mixture thereof). For example, the catholyte 340C may be 0.2 M NaCl in methanol. The anolyte 342C may include the electrolyte salt and water, organic alcohol, or a mixture of water and organic alcohol as solvent. For example, the anolyte 342B may include 0.2 M NaCl in water.

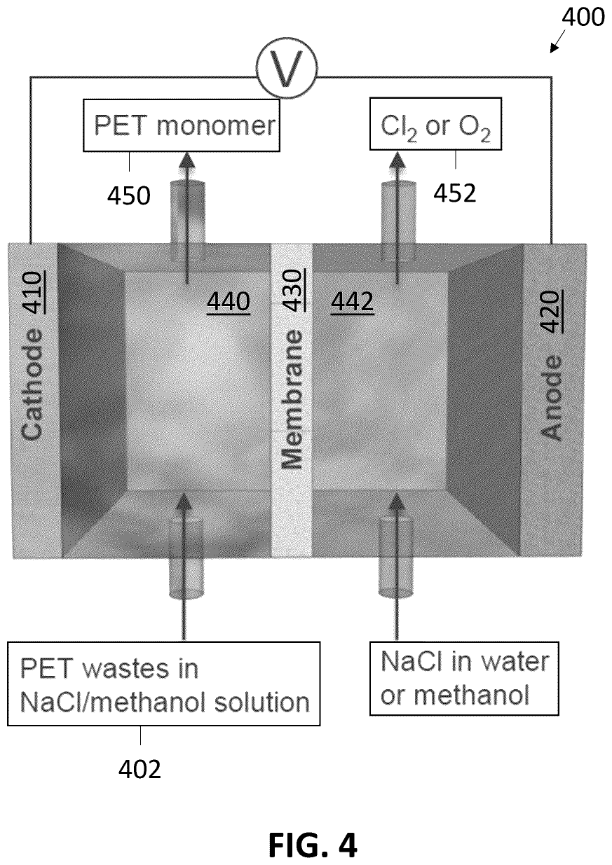

FIG. 4 is a schematic illustration of another electrochemical cell 400 for electrochemically recycling polyester and polyurethane polymers. The electrochemical cell 400 may be a flow cell, providing continuous depolymerization. The electrochemical cell 400 includes a cathode 410, an anode 420, and a membrane 430, similar to those used in the electrochemical cell 300 in FIG. 3. Polymer waste 402 (e.g., mixed plastic waste including PET) in catholyte 440 is fed into the cathode-side of the electrochemical cell 400 and anolyte 442 is fed into the anode-side of the electrochemical cell 400. Electrochemical depolymerization occurs within the cell, producing monomers 450 on the cathode side and Cl₂ or O₂ gas on the anode side.

Electrolyte solvents may be captured and recycled to minimize waste generation and reduce environmental impact.

The electrochemical cells 300 and 400 may not include an external heat source. During the electrochemical reaction, the temperature of the catholyte and anolyte may increase slightly. The temperature inside of the electrochemical cell during operation may be about 15° C. to about 45° C., and any value therebetween.

The present invention, thus generally described, will be understood more readily by reference to the following examples, which are provided by way of illustration and are not intended to be limiting of the present invention.

### EXAMPLES

### Example 1: Depolymerization of Polyester

A batch-type electrochemical cell according to FIG. 3 was used for experiments. The catholyte included 0.2 M NaCl dissolved in methanol (MeOH) and the anolyte included 0.2 M NaCl in water. The membrane separating the catholyte and anolyte was a NASICON membrane. No external heating was used during operation. The applied current density was 25 mA/cm². PET was disposed on the cathode-side of the cell in the catholyte in an electrochemical cell in a concentration of 0.2 g PET per 20 mL solvent. PET was in the form of a powder.

The electrochemical depolymerization process was compared to conventional methods to depolymerize PET. Conventional methods included those disclosed in Zhang, et al., Cosolvent-promoted selective non-aqueous hydrolysis of PET wastes and facile product separation, Green Chemistry 2022, 24, (8), 3284-3292 (“Reference 1”); Pham, et al., Low-energy catalytic methanolysis of poly(ethyleneterephthalate), Green Chemistry 2021, 23, (1), 511-525 (“Reference 2”); and Rubio et al., Instantaneous hydrolysis of PET bottles: an efficient pathway for the chemical recycling of condensation polymers, Green Chemistry 2021, 23, (24), 9945-9956 (“Reference 3”), all of which are incorporated by reference herein.

Results are shown in Table 1. Electrochemical depolymerization resulted in a high conversion yield and rate of 97% depolymerization in 4 hours without any external heating and without any caustic base. The electrochemical depolymerization reactions increased the cell temperature to 40° C.

TABLE 1

| Entry | Solvent | Base | Temp | Time | Conversion |
|---|---|---|---|---|---|
| Reference 1 | THF | 1M KOH | 60° C. | 1 h | 100% |
| Reference 2 | MeOH | 1M K₂CO₃ | RT | 24 h | 100% |
| Reference 3 | MeOH | 1M NaOH | RT | 4 h | 94% |
| Electrochemical | MeOH | — | 40° C. | 4 h | 97% |
| Depolymerization | | | | | |

### Example 2: Depolymerization of Polyurethane

A batch-type electrochemical cell according to FIG. 3 was used for experiments. The catholyte included 0.2 M NaCl dissolved in methanol (MeOH) or butanol (BuOH); and the anolyte included 0.2 M NaCl in water. The membrane separating the catholyte and anolyte was a NASICON membrane. No external heating was used during operation. The applied current density was 25 mA/cm². Polyurethane was disposed on the cathode-side of the cell in the catholyte in an electrochemical cell in a concentration of 0.2 g polyurethane per 20 mL solvent. Polyurethane was in the form of a powder

The electrochemical depolymerization process was compared to conventional methods to depolymerize polyurethane. Conventional methods included those disclosed in Zhao et al., Recycling Polyurethanes through Transcarbamoylation, ACS Omega 2021, 6, (6), 4175-4183 (“Reference 4”), which is incorporated by reference herein.

Results are shown in Table 2. Electrochemical depolymerization of polyurethane resulted in a conversion yield and rate of 53% depolymerization in 12 hours in butanol without any external heating and without any caustic base. The conversion yield in methanol was less. The electrochemical depolymerization reactions increased the cell temperature to 40° C.

TABLE 2

| Entry | Solvent | Base | Temp | Time | Conversion |
|---|---|---|---|---|---|
| Reference 4 | MeOH/ | 2 eq. tert- | 65° C. | 20 h | 79% |
| | THF | butoxide | | | |
| Electrochemical | BuOH | — | 40° C. | 12 h | 53% |
| Depolymerization | | | | | |
| Electrochemical | MeOH | — | 40° C. | 12 h | 12% |
| Depolymerization | | | | | |

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A method of depolymerization comprising:
passing a current through a cathode to form alkoxy anions from an alcohol, the alkoxy anions reacting with a polyester and/or a polyurethane to form monomers from the polyester and/or the polyurethane.

2. The method of claim 1, wherein the alcohol comprises methanol, ethanol, propanol, butanol, pentanol, hexanol, or a mixture thereof.

3. The method of claim 1, wherein the alkoxy anions comprise methoxy anions, ethoxy anions, propoxy anions, butoxy anions, pentoxy anions, hexoxy anions, or a mixture thereof.

4. The method of claim 1, wherein the polyester comprises poly(ethylene terephthalate) (PET), polytrimethylene terephthalate (PTT), poly(butylene terephthalate) (PBT), poly(hexamethylene terephthalate)(PHT), or a combination of two or more thereof.

5. The method of claim 1, wherein the polyester comprises polyethylene terephthalate (PET).

6. The method of claim 5, wherein the monomers formed from PET depolymerization comprise dimethyl terephthalate (DMT).

7. The method of claim 5, wherein the monomers formed from PET depolymerization comprise terephthalic acid (TPA).

8. The method of claim 1, wherein the polyester and/or the polyurethane are waste materials.

9. The method of claim 1, further comprising isolating the monomers from the alcohol.

10. The method of claim 9, wherein isolating the monomers from the alcohol comprises passing the monomers through a filter in the presence of an organic solvent in which the monomers are soluble.

11. An electrochemical device comprising:
a cathode;
a catholyte in physical contact with the cathode, the catholyte comprising an alcohol and an electrolyte salt including cations;
an anode in electrical communication with the cathode;
an anolyte in physical contact with the anode;
a separator separating the catholyte and the anolyte, the separator configured to conduct the cations between the catholyte and the anolyte; and
a polyester and/or polyurethane disposed in the catholyte.

12. The electrochemical device of claim 11, wherein the alcohol comprises methanol, ethanol, propanol, butanol, pentanol, hexanol, or a mixture thereof.

13. The electrochemical device of claim 11, wherein the catholyte further comprises alkoxy anions.

14. The electrochemical device of claim 13, wherein the alkoxy anions comprise methoxy anions, ethoxy anions, propoxy anions, butoxy anions, pentoxy anions, hexoxy anions, or a mixture thereof.

15. The electrochemical device of claim 11, wherein the anolyte comprises water, the alcohol, or a mixture thereof.

16. The electrochemical device of claim 11, further comprising a power source in electrical communication with the cathode.

17. The electrochemical device of claim 11, wherein the separator is a NASICON membrane or a polymer-based cation exchange membrane.

18. The electrochemical device of claim 11, wherein the polyester comprises poly(ethylene terephthalate) (PET), polytrimethylene terephthalate (PTT), poly(butylene terephthalate) (PBT), poly(hexamethylene terephthalate) (PHT), or a combination of two or more thereof.

19. The electrochemical device of claim 11, wherein the polyester comprises polyethylene terephthalate (PET).

20. A process for depolymerizing polyurethane using an electrochemical device, the electrochemical device comprising:
a cathode;
a catholyte in physical contact with the cathode. the catholyte comprising an alcohol;
the polyurethane disposed in the catholyte; and
the process comprising:
passing a current through the cathode to form alkoxy anions from the alcohol, the alkoxy anions reacting with the polyurethane to form dimethyl carbamate (DMC).
